(19) United States
(12) Patent Application Publication
(10) Pub. No.: US 2025/0291571 A1
(43) Pub. Date: Sep. 18, 2025

(54) UPDATING AN OPERATING SYSTEM IMAGE USING BINARY LARGE OBJECT FILES

(71) Applicant: RED HAT, INC., Raleigh, NC (US)

(72) Inventor: Giuseppe Scrivano, Rome (IT)

(21) Appl. No.: 18/604,601

(22) Filed: Mar. 14, 2024

(51) Int. Cl. G06F 8/65

(52) U.S. Cl. CPC G06F 8/65

(57) ABSTRACT

Techniques for atomic live updates to operating systems are described herein. For example, a computing system can generate a first version of a binary large object (BLOB) file indicating first metadata for each file of a first version of an image for an operating system. The computing system can generate a second version of the BLOB file indicating second metadata for each file of a second version of the image. The second version can include new files associated with an update to the operating system. The computing system can execute the update to the operating system by remounting, by a file system for the operating system, the second version of the image of the operating system using the second metadata of the second version of the BLOB file.

### TECHNICAL FIELD

The present disclosure relates generally to operating systems. More specifically, but not by way of limitation, this disclosure relates to executing atomic live updates to an operating system using binary large object files.

### BACKGROUND

Computing systems can use operating systems to manage system processes and resources, both software and hardware. An operating system can coordinate access to a computing system's central processing unit (CPU, memory, and storage). An image (e.g., an image file) of the operating system can be captured and stored in a storage device of the computing system. The image can include multiple layers of software or libraries, along with metadata indicating a relationship between the layers.

### BRIEF DESCRIPTION OF THE DRAWINGS

FIG. 1 is a block diagram of an example of a computing environment for atomic live updates of an operating system, according to some aspects of the present disclosure.

FIG. 2 is a flow diagram of another example of a computing environment for atomic live updates of an operating system, according to some aspects of the present disclosure.

FIG. 3 is a flow chart of an example of a process for executing atomic live updates of an operating system, according to some aspects of the present disclosure.

### DETAILED DESCRIPTION

Updating an operating system of a computing system may typically involve a set of software packages that are installed or updated sequentially. During the update, there may be a mix of software packages that have already been updated and other software packages that have not yet been updated. This mix of updated and nonupdated software packages may cause the operating system to be unstable. For instance, random failures may result from mismatched versions of software packages. If the update is unsuccessful, the operating system may be left in a broken state, which may require a manual fix. In other instances, A/B deployment of the update may be performed in which a new version of the operating system is installed in a separate directory. The computing system may then reboot with the new version of the operating system. Rebooting can involve downtime of the computing system even when the update does not involve the kernel.

Some examples of the present disclosure can overcome one or more of the abovementioned problems by mounting a system image out of a descriptor binary large object (BLOB) file to perform an atomic live update on an operating system. A BLOB file can store binary data as a single object. In an atomic update, if all software packages are installed successfully, the operating system update can be completed. If all software packages are not installed successfully, the operating system may revert back to a previous version. This can avoid partially installing dependencies without completely updating the operating system. Mounting the update out of a BLOB file can significantly reduce time required to perform the update, thus reducing the risk of random failures. Services that are not affected by the update may continue executing during the update. Further, unlike A/B deployment of updates, updating techniques described herein may be implemented without rebooting the computer system.

In a particular example, a server with an operating system may execute multiple services. A file system (e.g., composefs) for files of the operating system may be mounted. For example, the file system may be backed by an image file (also referred to herein as an image) of the operating system. The file system may include a directory structure and file metadata for the operating system. The file metadata may be stored as a BLOB file that contains pointers to the location of the files for the operating system. Prior to an update, the server may use a first version of the image of the operating system. The file system may include a first version of the BLOB file that corresponds to the first version of the image.

To update to a new version of the update system, the server can access new (e.g., missing or adjusted) files for the update. The new files can be added to storage. Once the new files are present locally, the server can generate a new version of the BLOB file (e.g., a second version). This second version of the BLOB file can include metadata, including pointers to file locations, for files in an updated version of the operating system. Specifically, the second version of the BLOB file can include metadata pointing to the new files for the update. Then, the file system can be used to remount for the existing mount of the file system. The remount can involve remounting to a second version of the image of the operating system by atomically switching from the first version of the BLOB file to the second version of the BLOB file. Thus, at any point during the update, the server may use either the first version of the BLOB file or the second version of the BLOB file. Thus, the server may continue execution without being rebooted during deployment of the update.

In some examples, services that are unaffected by the update may continue to execute during the deployment of the update. For example, before deploying the update, the server can identify services that may access the new files for the update. Such services are affected by the update and thus may experience failures if they continue to execute during the update. Execution of these services may therefore be stopped before implementing the update. Services that do not access the new files (e.g., are unaffected by the updated) may not be stopped (e.g., may continue executing while the update is implemented). Once the atomic update has been completed (e.g., all packages have been installed correctly), execution of the affected services can be restarted. Thus, random failures of a live update can be prevented while minimizing downtime for services executed by the server.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

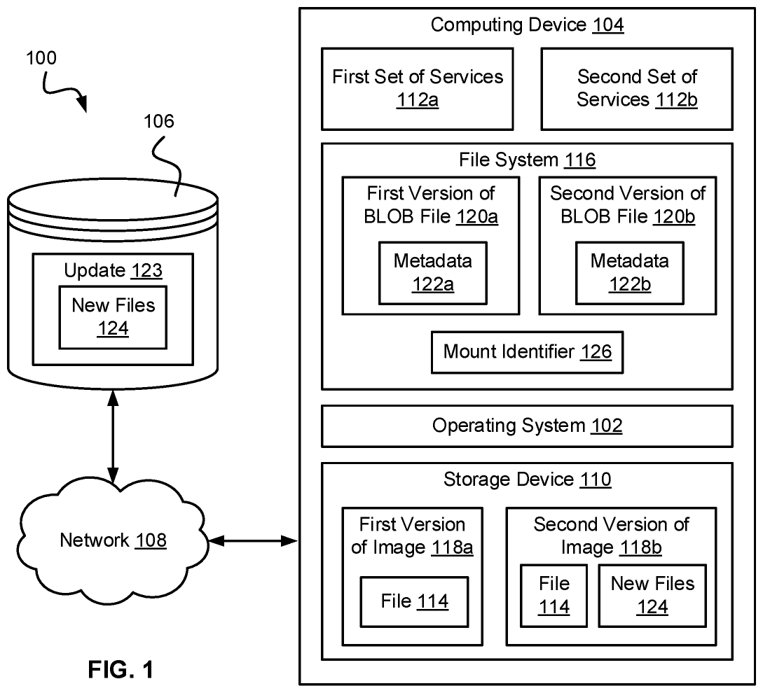

FIG. 1 is a block diagram of an example of a computing environment 100 for atomic live updates of an operating system 102, according to some aspects of the present disclosure. The computing environment 100 includes a computing device 104, such as a server, a laptop computer, desktop computer, mobile device, or any other suitable computing device. The computing device 104 can be in communication with a software repository 106 via a network 108, such as a local area network (LAN), a wide area network (WAN), a wide local area network (WLAN), the Internet, or any combination of these.

The computing device 104 may include hardware, such as a storage device 110, and software, such as the operating system 102 as well as a first set of services 112a and a second set of services 112b that can be executed by the operating system 102. The operating system 102, such as the Linux operating system, can manage the hardware and software resources for the computing device 104. For example, the operating system 102 can act as an intermediary between the services 112a-b (and any other processes, applications, programs, software, etc. for the computing device 104) and hardware of the computing device 104. Files 114 for the operating system 102 (e.g., as part of an image of the operating system 102) can be stored in the storage device 110. For example, a file system 116 for the operating system 102 can be mounted that can be backed by a first version of an image 118a of the operating system 102. The first version of the image 118a may be used by the operating system 102 prior to an update 123.

The file system 116 can include a binary large object (BLOB) file that stores binary data, including a directory structure and metadata for the files 114 in the operating system 102. For example, prior to the update 123, the file system 116 can include a first version of a BLOB file 120a with first metadata 122a. The first metadata 122a can include any type of metadata for the files 114, including pointers to file locations for the files 114. For example, for each inode, the first version of the BLOB file 120a can store a path to a corresponding file 114. The first version of the BLOB file 120a may not include the files 114 or data from the files 114. One example of the file system 116 can be composefs, which can store each file 114 by its payload checksum. Thus, the first version of the BLOB file 120a can include pointers to the actual payload files 114.

An update 123 to the operating system 102 can be performed atomically and without requiring a reboot of the computing device 104. To execute the update 123, the computing device 104 can retrieve new files 124 for the update 123. The new files 124 can include missing files (e.g., that are not included in the first version of the image 118a of the operating system 102). The new files 124 can also include replacement files for one or more files 114 in the first version of the image 118a of the operating system 102. The computing device 104 may retrieve the new files 124 from the software repository 106 via the network 108. In other examples, the new files 124 may be retrieved from any other source, such as a database, a server, a computing device, etc. The computing device 104 can store the new files 124 in the storage device 110. The new files 124 may be stored separately from the files 114 for the first version of the image 118a. Examples of the storage device 110 can include hard disks, flash drives, floppy disks, solid state drives (SSDs), virtual or cloud storage, or any other suitable type of storage for a computing device.

In some examples, before the update 123 is implemented, the computing device 104 can stop services that will be affected by the update 123. For example, the computing device 104 can identify a first set of services 112a that can access the new files 124. Neglecting to stop the first set of services 112a before the update 123 may cause random failures, as the first set of services 112a may access incompatible versions of files if the update 123 is not yet complete. The remainder of the services on the computing device (e.g., a second set of services 112b) may not be affected by the update 123, as the second set of services 112b may not access the new files 124. Thus, the second set of services 112b can continue to execute while the update 123 is being performed. It may be unlikely that execution of the second set of services 112b will cause random failures.

Once execution of the first set of services 112a has been stopped, the update 123 can be implemented. To start the update 123, the file system 116 can generate a second version of the BLOB file 120b for the update 123. The second version of the BLOB file 120b may not include the data from the files 114 or the new files 124. The second version of the BLOB file 120b can include second metadata 122b that stores location information (as well as any other metadata) for existing files 114 for the operating system 102 (e.g., that remain unmodified by the update 123), as well as the new files 124 now stored in the storage device 110. Thus, the second version of the BLOB file 120b can include second metadata 122b for an updated version of the operating system 102 (e.g., that has thus far not been executed). In some examples, the second metadata 122b may include a file path or pointers to the location of the files 114 and new files 124 within the storage device 110.

After storage of the new files 124 in the storage device 110, the computing device 104 may execute the update 123 to the operating system 102 by remounting the file system 116. The file system 116 can remount a second version of the image 118b of the operating system 102 using the second version of the BLOB file 120b. The second version of the image 118b can be the updated operating system 102 (e.g., updated according to update 123). In some examples, remounting the file system 116 using the second version of the BLOB file 120b to mount the second version of the image 118b can involve switching locations of file access. For example, the computing device may initially access a file 114 stored at a first location in the storage device 110. This first location may be indicated (e.g., via a pointer) by the first metadata 122a of the first version of the BLOB file 120a. But, the file 114 may be replaced with a new file 124 that is stored at a second location in the storage device 110. This second location may be indicated (e.g., via a pointer) by the second metadata 122b of the second version of the BLOB file 120b. Thus, the update 123 can be executed by switching the computing device 104 from accessing the file 114 via the first location to accessing the new file 124 via the second location (as determined from the second metadata 122b).

The file system 116 can be remounted for an existing mount of the file system 116, but using the second version of the image 118b instead of the first version of the image 118a. That is, remounting the file system 116 to execute the update 123 may not involve mounting separate file systems 116. From a perspective of the operating system 102, the same mount may be used for the remounted file system 116. For example, the file system 116 may store (e.g., within the BLOB files 120a-b) a mount identifier 126 associated with the file system 116. The mount identifier 126 for the file system 116 can be the same before and after the update 123 is performed. The operating system 102 may, in some examples, use the mount identifier 126 when accessing files 114. Maintaining the same mount identifier 126 by using a single file system 116 to execute the update 123 may simplify operations and prevent issues that may be caused by having multiple mount identifiers.

The update 123 may be an atomic update in which, at any time during the update, the computing device 104 may be using either the first version of the BLOB file 120a or the second version of the BLOB file 120b. Further, if any portion of the update 123 fails, the computing device 104 can revert back to use of the first version of the image 118a instead of having a partial update that may be difficult to resolve. The update 123 may also be a live update in which the computing device 104 continues to perform operations (e.g., executing the second set of services 112b) while the file system 116 remounts the second version of the image 118b. The computing device 104 may not be rebooted or experience downtime during, before, or after the update 123. This can substantially reduce time and computing resources required to update the operating system 102.

Because the second set of services 112b are unaffected by the update 123, the second set of services 112b may continue to be executed by the computing device 104 during the update 123 as if an update were not occurring. The first set of services 112a that are affected by the update 123 may not execute during the update 123. The computing device 104 may determine that the update 123 has been successfully completed. For example, the computing device 104 may determine that all files, packages, libraries, data, etc. for the second version of the image 118b have successfully been installed for the operating system 102. In response to determining that the update 123 has been successfully completed, the computing device 104 may restart execution of the first set of services 112a. Subsequently, the first set of services 112a may access the new files 124 from the second version of the image 118b of the operating system 102.

The example shown in FIG. 1 is illustrative, but various modifications are possible. For example, while FIG. 1 depicts a specific arrangement of components, other examples can include more components, fewer components, different components, or a different arrangement of the components shown in FIG. 1. Additionally, any component or combination of components depicted in FIG. 1 can be used to implement the process(es) described herein. Further, while certain components are depicted in FIG. 1 as being internal or external to the computing device 104, other examples can involve other configurations of the components. For example, the storage device 110, first set of services 112a, second set of services 112b, or any combination of these can be separate from the computing device 104 and accessible to the computing device 104 via the network 108.

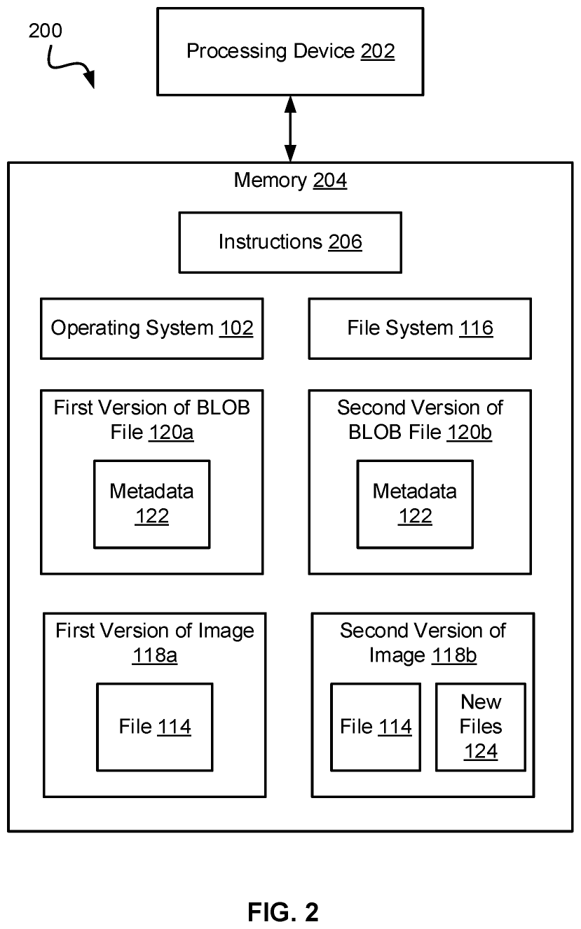

FIG. 2 is a flow diagram of another example of a computing environment 200 for atomic live updates of an operating system 102, according to some aspects of the present disclosure. The computing environment 200 can include a processing device 202 communicatively coupled to a memory device 204. In some examples, the processing device 202 and the memory device 204 can be housed in a single device, such as computing device 104 of FIG. 1. In other examples, the processing device 202 and the memory device 204 can be distributed from one another.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the memory device 204 can store instructions 206 that can be executable by the processing device 202 to update an operating system 102. For example, the processing device 202 may generate a first version of a binary large object (BLOB) file 120a indicating first metadata 122a for each file 114 of a first version of an image 118a for the operating system 102. The processing device 202 may store a plurality of new files 124 associated with an update to the operating system 102. The processing device 202 can generate a second version of the BLOB file 120b indicating second metadata 122b for each file of a second version of the image 118b of the operating system 102. The second version of the image 118b can comprise the plurality of new files 124. The processing device 202 can execute the update to the operating system 102 by remounting, by a file system 116 for the operating system 102, the second version of the image 118b of the operating system 102 using the second metadata 122b from the second version of the BLOB file 120b.

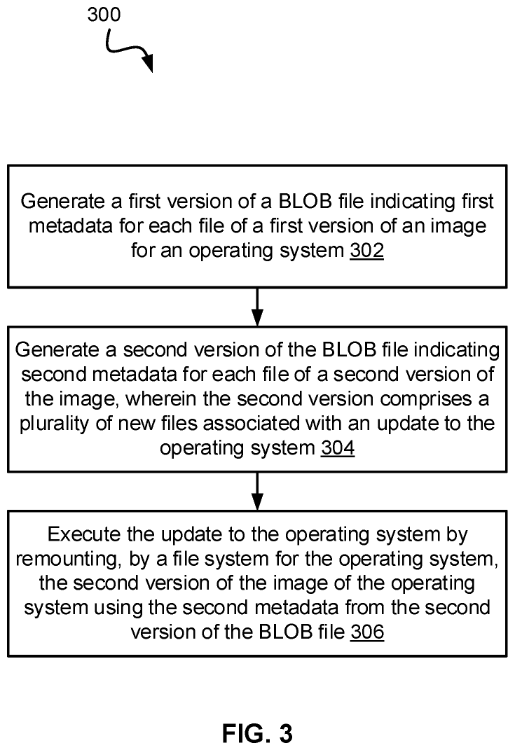

In some examples, the computing environment 200 can implement the process 300 shown in FIG. 3, which is a flow chart of an example of a process for executing atomic live updates of an operating system, according to some aspects of the present disclosure. Other examples can include more steps, fewer steps, different steps, or a different order of the steps that are depicted in FIG. 3. The steps of FIG. 3 are described with reference to the components discussed above with regard to FIGS. 1-2.

At block 302, the processing device 202 can generate a first version of a BLOB file 120a indicating first metadata 122a for each file 114 of a first version of an image 118a for an operating system 102. In some examples, prior to generating the first version of the BLOB file 120a, the processing device 202 can mount, by the file system 116, the first version of the image 118a of the operating system 102. The first metadata 122a can include, for each file 114 of the operating system 102 (e.g., the first version of the image 118a of the operating system 102), a location of the file 114.

To execute an update 123 to the operating system 102, the processing device 202 can store a plurality of new files 124 associated with an update 123 to the operating system 102. In some examples, the processing device 202 can identify a first set of services 112a that may have access to the plurality of new files 124 subsequent to execution of the update 123. Execution of the first set of services 112a can be stopped prior to remounting a second version of the image 118b of the operating system 102. The processing device 202 can also identify a second set of services 112b that may lack access to the plurality of new files 124 subsequent to execution of the update 123. Execution of the second set of services 112b may continue while remounting the second version of the image 118b of the operating system 102.

At block 304, the processing device 202 can generate a second version of the BLOB file 120b indicating second metadata 122b for each file of a second version of the image 118b of the operating system 102. The second version of the image 118b of the operating system 102 can comprise the plurality of new files 124 associated with the update 123 to the operating system 102. The second metadata 122b in the second version of the BLOB file 120b may include pointers to the new files 124. In some examples, one or more of the new files 124 may be a replacement file for one or more of the files 114 in the first version of the image 118a of the operating system 102.

At block 306, the processing device 202 can execute the update 123 to the operating system 102 by remounting, by a file system 115 for the operating system 102, the second version of the image 118b of the operating system 102 using the second version of the BLOB file 120b. The update 123 to the operating system 102 can be executed while running the operating system 102. That is, the operating system 102 may not have any downtime while the update 123 is implemented. The update 123 can be executed by the processing device 202 switching from accessing a file 114 via a first location indicated by the first metadata 122a for the first version of the BLOB file 120a to a second location indicated by the second metadata 122b of the second version of the BLOB file 120b.

In some examples, subsequent to remounting the second version of the image 118b of the operating system 102 to update the operating system 102, execution of the first set of services 112a can be restarted. After the update 123, the first set of services 112a may access the new files 124. The file system 116 may have a same mount identifier 126 used by the operating system 102 both prior to execution of the update 123 and subsequent to execution of the update 123.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. The examples disclosed herein may be combined or rearranged to yield additional examples.

What is claimed is:

1. A system comprising:
a processing device; and
a non-transitory memory comprising instructions that are executable by the processing device for causing the processing device to:
generate a first version of a binary large object (BLOB) file indicating first metadata for each file of a first version of an image for an operating system;
generate a second version of the BLOB file indicating second metadata for each file of a second version of the image, wherein the second version comprises a plurality of new files associated with an update to the operating system; and
execute the update to the operating system by remounting, by a file system for the operating system, the second version of the image of the operating system using the second metadata from the second version of the BLOB file.

2. The system of claim 1, wherein the memory further comprises instructions that are executable by the processing device for causing the processing device to:
identify a first set of services having access to the plurality of new files subsequent to execution of the update;
stop execution of the first set of services prior to remounting the second version of the image of the operating system; and
restart execution of the first set of services subsequent to remounting the second version of the image of the operating system.

3. The system of claim 2, wherein the memory further comprises instructions that are executable by the processing device for causing the processing device to:
identify a second set of services lacking access to the plurality of new files subsequent to execution of the update; and
continue execution of the second set of services while remounting the second version of the image of the operating system.

4. The system of claim 1, wherein the memory further comprises instructions that are executable by the processing device for causing the processing device to, prior to generating the first version of the BLOB file:
mount, by the file system, the first version of the image of the operating system.

5. The system of claim 1, wherein the first metadata or the second metadata comprises, for each file of the operating system, a location of the file, and wherein the memory further comprises instructions that are executable by the processing device for causing the processing device to execute the update to the operating system by:
switching from accessing a file via a first location indicated by the first metadata of the first version of the BLOB file to a second location indicated by the second metadata of the second version of the BLOB file.

6. The system of claim 1, wherein the memory further comprises instructions that are executable by the processing device for causing the processing device to execute the update to the operating system while running the operating system.

7. The system of claim 1, wherein the file system has a same mount identifier used by the operating system prior to execution of the update and subsequent to execution of the update.

8. A method comprising:
generating, by a processing device, a first version of a binary large object (BLOB) file indicating first metadata for each file of a first version of an image for an operating system;
generating, by the processing device, a second version of the BLOB file indicating second metadata for each file of a second version of the image, wherein the second version comprises a plurality of new files associated with an update to the operating system; and
executing the update to the operating system by remounting, by the processing device executing a file system for the operating system, the second version of the image of the operating system using the second metadata of the second version of the BLOB file.

9. The method of claim 8, further comprising:
identifying a first set of services having access to the plurality of new files subsequent to execution of the update;
stopping execution of the first set of services prior to remounting the second version of the image of the operating system; and
restarting execution of the first set of services subsequent to remounting the second version of the image of the operating system.

10. The method of claim 9, further comprising:
identifying a second set of services lacking access to the plurality of new files subsequent to execution of the update; and
continuing execution of the second set of services while remounting the second version of the image of the operating system.

11. The method of claim 8, further comprising, prior to generating the first version of the BLOB file:
mounting, by the file system, the first version of the image of the operating system.

12. The method of claim 8, wherein the first metadata or the second metadata comprises, for each file of the operating system, a location of the file, and wherein executing the update to the operating system further comprises:
switching from accessing a file via a first location indicated by the first metadata of the first version of the BLOB file to a second location indicated by the second metadata of the second version of the BLOB file.

13. The method of claim 8, further comprising executing the update to the operating system while running the operating system.

14. The method of claim 8, wherein the file system has a same mount identifier used by the operating system prior to execution of the update and subsequent to execution of the update.

15. A non-transitory computer-readable medium comprising program code that is executable by a processing device for causing the processing device to:
generate a first version of a binary large object (BLOB) file indicating first metadata for each file of a first version of an image for an operating system;
generate a second version of the BLOB file indicating second metadata for each file of a second version of the image, wherein the second version comprises a plurality of new files associated with an update to the operating system; and
execute the update to the operating system by remounting, by a file system for the operating system, the second version of the image of the operating system using the second metadata of the second version of the BLOB file.

16. The non-transitory computer-readable medium of claim 15, wherein the program code is further executable by the processing device for causing the processing device to:
identify a first set of services having access to the plurality of new files subsequent to execution of the update;
stop execution of the first set of services prior to remounting the second version of the image of the operating system; and
restart execution of the first set of services subsequent to remounting the second version of the image of the operating system.

17. The non-transitory computer-readable medium of claim 16, wherein the program code is further executable by the processing device for causing the processing device to:
identify a second set of services lacking access to the plurality of new files subsequent to execution of the update; and
continue execution of the second set of services while remounting the second version of the image of the operating system.

18. The non-transitory computer-readable medium of claim 15, wherein the program code is further executable by the processing device for causing the processing device to, prior to generating the first version of the BLOB file:
mount, by the file system, the first version of the image of the operating system.

19. The non-transitory computer-readable medium of claim 15, wherein the first metadata or the second metadata comprises, for each file of the operating system, a location of the file, and wherein the program code is further executable by the processing device for causing the processing device to execute the update to the operating system by:
switching from accessing a file via a first location indicated by the first metadata of the first version of the BLOB file to a second location indicated by the second metadata of the second version of the BLOB file.

20. The non-transitory computer-readable medium of claim 15, wherein the program code is further executable by the processing device for causing the processing device to execute the update to the operating system while running the operating system.
